(19) United States
(12) Patent Application Publication
(10) Pub. No.: US 2014/0279987 A1
(43) Pub. Date: Sep. 18, 2014

(54) WORKFLOW DESIGN FOR LONG-RUNNING DISTRIBUTED OPERATIONS USING NO SQL DATABASES

(71) Applicants: Pablo Chico de Guzman Huerta, Murica (ES); Alberto Arias Maestro, Mountain View, CA (US)

(72) Inventors: Pablo Chico de Guzman Huerta, Murica (ES); Alberto Arias Maestro, Mountain View, CA (US)

(21) Appl. No.: 14/206,342

(22) Filed: Mar. 12, 2014

Related U.S. Application Data
(60) Provisional application No. 61/780,603, filed on Mar. 13, 2013.

(51) Int. Cl. G06F 9/52; G06F 9/46

(52) U.S. Cl. CPC G06F 9/52; G06F 9/466
USPC 707/704

(57) ABSTRACT

Transactions or operations associated with a received request are performed with a NoSQL database. A request ID is assigned to the request, an operation ID to the operation, and an entity ID to the entity associated with the operation. The entity is locked in the database, and the operation is performed. The database is unlocked, and a message is transmitted to a lock queue to release an entry therein associated with the request. If a second request attempt to lock the same entity while the first is concurrent, it requests that the lock queue inform it when the lock is released.

### CROSS-REFERENCE TO RELATED APPLICATIONS

This application claims priority to and the benefit of U.S. Provisional Patent Application Ser. No. 61/780,603, filed on Mar. 13, 2013, which is hereby incorporated herein by reference in its entirety.

### TECHNICAL FIELD

Embodiments of the present invention relate generally to NoSQL databases and, in particular, to locking and transaction functions thereof.

### BACKGROUND

A NoSQL database provides a mechanism for storage and retrieval of data that is modeled in means other than the tabular relations used in relational databases. NoSQL databases have been shown as a high-performance technology to deal with huge amounts of data; the tradeoff being, however, that NoSQL databases lack some powerful features of traditional SQL databases, such as, specifically, advanced-locking mechanisms and transactions (between others).

There are several solutions to provide locking mechanisms and transactions in the context of NoSQL databases, but they limit the benefits of NoSQL databases. For example, locking may be based on temporal locks; these locks are, however more complex to manage (e.g., a lock might be released before the corresponding operation has finished, and it is difficult to predict the execution time of a long running operation). In addition, transactions may be provided at the programming language level via two-phase commits, which have a non-negligible impact on database performance. A need therefore exists for a way to efficiently, quickly, and reliably perform locking and transactions in the context of NoSQL databases.

### SUMMARY

In general, various aspects of the systems and methods described herein perform transactions or operations associated with a received request with a NoSQL database. A request ID is assigned to the request, an operation ID to the operation, and an entity ID to the entity associated with the operation. The entity is locked in the database, and the operation is performed. The database is unlocked, and a message is transmitted to a lock queue to release an entry therein associated with the request. If a second request attempt to lock the same entity while the first is concurrent, it requests that the lock queue inform it when the lock is released.

A method for executing transactions with a NoSQL database includes receiving a request to perform an operation on an entity in a NoSQL database; assigning a request ID to the request, an operation ID to the operation, and an entity ID to the entity; locking the entity in the NoSQL database using the entity ID and request ID; performing the operation associated with the operation ID; unlocking the entity in the NoSQL database; and transmitting a message to a lock queue to release an entry therein associated with the request.

The method may further include receiving a second request to perform a second operation on the entity in the NoSQL database; receiving, from the NoSQL database, a message indicating that locking the entity in the database is blocked; requesting, from the lock queue, to be notified upon release of the entity; and receiving notification of release of the entity from the lock queue in response to transmission of the message to the lock queue to release the entity therein. The request, request ID, operation ID, and entity ID may be inserted into an operation queue. Locking the entity in the NoSQL database may include inserting the entity ID and request ID into a lock table. Performing the operation associated with the operation ID may include accessing an entity table. The request may be authenticated and validated. The operation may be an idempotent operation. The operation may be re-performed if it fails.

In another aspect, a system for executing transactions with a NoSQL database includes computer processors configured for executing computer instructions for computationally executing the steps of: receiving a request to perform an operation on an entity in a NoSQL database; assigning a request ID to the request, an operation ID to the operation, and an entity ID to the entity; locking the entity in the NoSQL database using the entity ID and request ID; performing the operation associated with the operation ID; unlocking the entity in the NoSQL database; and transmitting a message to a lock queue to release an entry therein associated with the request; and a database for storing performance data related to the execution of the plurality of virtual machines.

The computer processors may computationally execute the additional steps of receiving a second request to perform a second operation on the entity in the NoSQL database; receiving, from the NoSQL database, a message indicating that locking the entity in the database is blocked; requesting, from the lock queue, to be notified upon release of the entity; and receiving notification of release of the entity from the lock queue in response to transmission of the message to the lock queue to release the entity therein.

The computer processors may computationally execute the additional steps of inserting the request, request ID, operation ID, and entity ID into an operation queue. Locking the entity in the NoSQL database may include inserting the entity ID and request ID into a lock table. Performing the operation associated with the operation ID may include accessing an entity table. The computer processors may computationally execute the additional steps of authenticating and validating the request. The operation may be an idempotent operation. The computer processors may computationally execute the additional steps of re-performing the operation if it fails.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates a locking and transaction system for NoSQL databases in accordance with embodiments of the present invention;

FIG. 2 illustrates an exemplary workflow diagram of concurrent NoSQL database requests in accordance with embodiments of the present invention; and

FIG. 3 illustrates an exemplary server in accordance with embodiments of the present invention.

### DETAILED DESCRIPTION

FIG. 1 illustrates a computing environment 100 that includes web servers 102, a distribute-message server 104, workflows 106, and a NoSQL database 108. A web server 102 electronically receives a request (from a user, system, software, or other source) to perform a database operation (such as reading or writing information) on a particular entity within the database. Multiple requests may be received concurrently and execute in parallel. A plurality of requests may require access the same entity to the NoSQL database 108 at the same time; as explained in greater detail below, the distribute-message server 104 coordinates locking of the NoSQL database 108 as necessary to ensure that concurrent access does not corrupt the NoSQL database 108 and/or access out-of-date data in the NoSQL database 108.

The web server 102 may analyze the request to verify its syntax and to validate it semantically. The request may also be analyzed for security to, for example, verify the authenticity of the request or requestor and/or to verify that fulfillment of the request is permitted for the requestor. If the analysis produces a negative result, the web server 102 may halt the request and so inform the user making the request. If not, the web server 102 may assign a unique request ID, an operation ID, and an entity ID to the request. The request ID may be used to identify the request throughout the elements depicted in the system 100 of FIG. 1 (as explained in greater detail below); the operation ID indicates the operation to be performed; and the entity ID identifies the particular entity upon which the operation is to be performed. As the term is used herein, “entity” refers to a data element or group of related data elements in the NoSQL database 108 for which concurrent access is not permitted.

The web server 102 sends the request, the request ID, the operation ID, and the entity ID to the distribute-message server 104; the request and associated IDs may be placed in an operations queue 110 for processing. Multiple incoming requests may be stored in the operations queue 110, and the distribute-message server 104 may process them in order of their arrival, in order of their priority, when available resources become available, or in any other order.

The distribute-message server 104 selects a request from the operations queue 110 and distributes it to one or more of a plurality of workflows 106. The workflows 106 may be programs, instances, functions, procedures, threads, or other such constructs of executable instructions that receive, process, order, and execute database or other instructions and optionally return the results thereof. The distribute-message server 104 may, when the request is so distributed, maintain the request in the operations queue 110. As described below, entries in the operation queue 110 are cleared when the associated workflow 106 sends an acknowledgement or similar signal to the distribute-message server 104. The distribute-message server 104 may further include a lock queue 112 for storing locks associated with concurrent requests for the same entity in the NoSQL database 108.

When a workflow 106 receives a request from the distribute-message server 104, it locks the entity associated with the request's entity ID by inserting a tuple (entity ID, request ID), or similar data, into a lock table 114 in the NoSQL database 108. If the lock is successful, the workflow 106 performs the operation associated with operation ID and accesses the corresponding entity 116 in the NoSQL database 108 accordingly. When the operation completes, the workflow 106 deletes the associated lock in the lock table 114.

Once the entity associated with the operation is unlocked, the workflow 106 sends an acknowledgement or similar signal to the distribute-message server 104 to so inform said server 104 that the operation is complete. When the distribute-message server 104 receives the acknowledgement, it deletes any corresponding lock in the lock queue 112 and may send a message to any other workflows waiting for release of the lock, as explained in greater detail below.

In one embodiment, a workflow 106 tries to lock an entity in the lock table 114, but cannot achieve said lock because another workflow 106 has already placed a lock on the entity. In this embodiment, the workflow 106 receives a message to this effect from the lock table 114. In response, the workflow 106 sends a request to the distribute-message server 104 to create an associated entry in the lock queue 112 and waits for a response. The request pends in the lock queue 112 until the other workflow 106 that created the lock completes its operation and sends a corresponding acknowledgement signal to the distribute-message server 104. When the acknowledgement signal is received, the distribute-message server 104 clears the corresponding entry in the lock queue 112 and sends a message to the waiting workflow 106, which then proceeds with its operation now that it can lock the entity in the NoSQL database 108.

In some embodiments, the operations executed by the workflows 106 are idempotent, meaning that they may be re-executed as many times as needed but with the same final result. Therefore, if a workflow 106 fails to complete an operation, the distribute-message server 104 re-sends the associated request to another workflow 106. The new workflow 106 may not need to re-lock the associated entity in the NoSQL database 108 if the failed workflow 106 did not release its lock; the same locking tuple (entity ID, request ID) may be used by both the failed and new workflows 106.

FIG. 2 illustrates a workflow diagram 200 of two concurrent requests, Request A and Request B, which may be received from two different users, that access the same entity. In first steps, not shown in the figure, web servers receive the requests and forward them, along with associated request IDs, operations IDs, and entity IDs to an operation queue 202 in a distribute-message server. The distribute-message server sends Request A to a first workflow 104 and Request B to a second workflow 106. The first workflow 104 creates a lock on the entity in a lock table 108 and accesses the entity associated with the request in an entity table 110 to perform the operation associated with the request. Concurrently, the second workflow 106 attempt to lock the entity in the lock table 108, but because the entity has already been locked by the first workflow 104, the second workflow 106 is blocked from said lock and must wait. The second workflow 106, in response to the block, creates an entry in the lock queue 112. Once the operation of workflow 104 completes, it releases the corresponding lock in the lock table 108 and sends a message to the lock queue 112 informing it of said release. The lock queue 112, in response, notifies the second workflow 106 of the release of said lock. In response, the second workflow 106 is finally able to lock the entity in the lock table 108 and proceed with the operation in its associated request.

FIG. 3 illustrates a computing system 300 (e.g., a server) in accordance with embodiments of the present invention. In this embodiment, the server 300 includes a processor 302, such as an INTEL XEON, non-volatile storage 304, such as a magnetic, solid-state, or flash disk, a network interface 306, such as ETHERNET or WI-FI, and a volatile memory 308, such as SDRAM. The storage 304 may store computer instructions which may be read into memory 308 and executed by the processor 302. The network interface 306 may be used to communicate with a requesting client, as described above. The present invention is not, however, limited to only the architecture of the server 300, and one of skill in the art will understand that embodiments of the present invention may be used with other configurations of servers or other computing devices.

The memory 308 may include instructions 310 for low-level operation of the server 300, such as operating-system instructions, device-driver-interface instructions, or any other type of such instructions. Any such operating system (such as WINDOWS, LINUX, or OSX) and/or other instructions are within the scope of the present invention, which is not limited to any particular type of operating system. The memory further includes instructions for a distribute-message server 312, operation queue 314, lock queue 316, web servers 318, workflows 320, lock table 322, and entity table 324. Again, the present invention is not limited to only this allocation of instructions and data, and any such arrangement is within its scope. In particular, the web servers 318, distribute-message server 312, workflows 320, and lock entity/tables 322, 324 (and their associated NoSQL database) may be disposed on different servers 300. The web servers 318, distribute-message server 312, and workflows 320 may be configured to scale up and down independently, based on their different behavior and computing demands placed thereon. In particular, scaling the workflow 320 may be as simple as starting more workflow instances because the distribute-message server 312 load-balances all messages between the different workflows 320 of the distribute-message server queues 314, 316.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for executing transactions with a NoSQL database, the method comprising:
receiving a request to perform an operation on an entity in a NoSQL database;
assigning a request ID to the request, an operation ID to the operation, and an entity ID to the entity;
locking the entity in the NoSQL database using the entity ID and request ID;
performing the operation associated with the operation ID;
unlocking the entity in the NoSQL database; and
transmitting a message to a lock queue to release an entry therein associated with the request.

2. The method of claim 1, further comprising:
receiving a second request to perform a second operation on the entity in the NoSQL database;
receiving, from the NoSQL database, a message indicating that locking the entity in the database is blocked;
requesting, from the lock queue, to be notified upon release of the entity; and
receiving notification of release of the entity from the lock queue in response to transmission of the message to the lock queue to release the entity therein.

3. The method of claim 1, further comprising inserting the request, request ID, operation ID, and entity ID into an operation queue.

4. The method of claim 1, wherein locking the entity in the NoSQL database comprises inserting the entity ID and request ID into a lock table.

5. The method of claim 1, wherein performing the operation associated with the operation ID comprises accessing an entity table.

6. The method of claim 1, further comprising authenticating and validating the request.

7. The method of claim 1, wherein the operation is an idempotent operation.

8. The method of claim 1, further comprising re-performing the operation if it fails.

9. A system for executing transactions with a NoSQL database, the system comprising:
computer processors configured for executing computer instructions for computationally executing the steps of:
i. receiving a request to perform an operation on an entity in a NoSQL database;
ii. assigning a request ID to the request, an operation ID to the operation, and an entity ID to the entity;
iii. locking the entity in the NoSQL database using the entity ID and request ID;
iv. performing the operation associated with the operation ID;
v. unlocking the entity in the NoSQL database; and
vi. transmitting a message to a lock queue to release an entry therein associated with the request; and
a database for storing performance data related to the execution of the plurality of virtual machines.

10. The system of claim 9, wherein the computer processors computationally execute the additional steps of:
receiving a second request to perform a second operation on the entity in the NoSQL database;
receiving, from the NoSQL database, a message indicating that locking the entity in the database is blocked;
requesting, from the lock queue, to be notified upon release of the entity; and
receiving notification of release of the entity from the lock queue in response to transmission of the message to the lock queue to release the entity therein.

11. The system of claim 9, wherein the computer processors computationally execute the additional steps of inserting the request, request ID, operation ID, and entity ID into an operation queue.

12. The system of claim 9, wherein locking the entity in the NoSQL database comprises inserting the entity ID and request ID into a lock table.

13. The system of claim 9, wherein performing the operation associated with the operation ID comprises accessing an entity table.

14. The system of claim 9, wherein the computer processors computationally execute the additional steps of authenticating and validating the request.

15. The system of claim 9, wherein the operation is an idempotent operation.

16. The system of claim 9, wherein the computer processors computationally execute the additional steps of re-performing the operation if it fails.
